(19) United States
(12) Patent Application Publication
(10) Pub. No.: US 2023/0259073 A1
(43) Pub. Date: Aug. 17, 2023

(54) METHOD FOR CONFIGURING COMPONENTS IN A SYSTEM BY MEANS OF MULTI-AGENT REINFORCEMENT LEARNING, COMPUTER-READABLE STORAGE MEDIUM, AND SYSTEM

(71) Applicant: SIEMENS AKTIENGESELLSCHAFT, München (DE)

(72) Inventors: Schirin Bär, Fürth (DE); Jörn Peschke, Nürnberg (DE); Michael Wieczorek, Erlangen (DE)

(21) Appl. No.: 18/008,578

(22) PCT Filed: Jun. 8, 2020
(86) PCT No.: PCT/EP2020/065850

§ 371 Date: Dec. 6, 2022

(51) Int. Cl. G05B 13/02; G05B 13/04

(52) U.S. Cl. CPC G05B 13/0265; G05B 13/042

(57) ABSTRACT

Software systems of a plurality of components often require said components to be configured so that said components can perform their task in an optimal manner for a particular application. A software system which consists of a plurality of components is configured. To this end, two different alternatives are provided: a) mode 1, i.e., with offensive training, for quickly learning new situations: the range of values and the step size of the parameters are restricted to such an extent that only non-critical changes are possible with one action. Alternatively, b) mode 2 is used, I.e., defensive training, with continuous learning: the range of values and the step size of the parameters are restricted so that the changes do not significantly worsen the target variables; the Epsilon-Greedy values is set to a lower value.

### RELATED CASE

The present patent document is a § 371 nationalization of PCT Application Serial Number PCT/EP2020/065850, filed Jun. 8, 2020, which is hereby incorporated by reference.

### BACKGROUND

Software systems of multiple components frequently require these components to be configured to allow optimum performance of the task of these components for a specific application. In simpler cases, this may be done manually or accomplished using a control loop.

Examples of such configurations are the distribution of computation load over multiple processor cores, size of the shared memory or the maximum possible number of communication packets.

If the influencing factors (manipulated variables, interference variables, controlled variables, and so on) become more numerous and the relationships more complex, finding an optimum is very difficult and may then be possible only by empirical optimization approaches or by an adapted/trained AI model using machine learning.

Put in quite general terms, machine learning may be broken down into unsupervised machine learning, supervised machine learning and reinforcement learning, which focuses on finding smart solutions to complex control problems.

The situation becomes even more difficult if the relevant component undergoes changes during runtime and training data are/were not available for these cases. The dynamic addition of further components having new parameters and influences also increases the complexity of the task further. Moreover, cross-component constraints also need to be observed. These may also change over the runtime/life of the component.

For aspects that arise only during runtime, such as changes within a component, addition of further components or changes in the higher-level constraints, it is usually necessary to adapt the configuration of the computer system. In the case of an AI-based solution, it then becomes necessary to retrain the AI model during the runtime of the full system. In this scenario, it must be ensured that no changes that lead to unwanted behaviour in the productive system are made during an exploration.

The adaptations in this scenario serve e.g., the following purposes:
increasing productivity,
improving quality,
increasing data throughput,
ensuring stability through to increasing stability,
increasing reserves for a maximum utilization capacity,
cushioning output peaks, and
early detection of instabilities (memory, network, communication, and so on).

One example of such a system is the central component of the Siemens HMI Operate—the control access point (CAP)—and also contributing components (COS-Task, NCK, and so on), the interaction of which may today be subject to a static configuration/parameterization during runtime and which may thus react to different load scenarios only inadequately, or not at all. In particular, for future applications in the field of OPC UA, big data, smart data, edge, modular control concepts or production/machine-specific applications, the performance capability of the more or less statically interacting components today will no longer be adequate, since primarily a greater data throughput needs to be achieved, but at the same time stability and reserves for potential load peaks need to be ensured.

Today, complex industrial control systems, such as e.g., CNC machines, having respective interacting components are frequently configured, or optimized, separately from one another. Adaptations for the trained system in the case of a variable environment—primarily during runtime—are, if at all, carried out manually.

By way of example, empirical values are used to manually (possibly even on an application-specific basis) alter a few manipulated variables of the system (e.g., the number of threads on the basis of the number of cores) before the control program is restarted, in order to parameterize the HMI Operate for a specific scenario. Only a few parameters may be adapted during the runtime of the system to ensure a higher throughput or better stability.

Solutions today do not allow for adaptations during runtime being able to be carried out only within a safe framework to prevent unwanted behaviour from arising during productive operation.

The document US 2019/0244099 A1 already describes a reinforcement learning system that performs training for a system during the runtime of the system, for example including in an industrial environment, for controlling robots for accomplishing a specific task.

### SUMMARY

Adaptation of the parameterization/configuration of complex systems is provided during runtime.

The problem is solved by a method, a computer-readable storage medium, and by a system.

The solution uses machine learning concepts.

The method is used to configure components in a system with factors that influence the components. The components are operatively linked to one another, and the state of each of the components is determinable by collecting internal measured variables. The state of the system is determinable by collecting measured variables relating to the full system by a reinforcement learning system. The reinforcement learning system is based on at least one agent and information relating to the associated environment. During the runtime of the system, the components in the system are initially put into a training mode to start a training phase in a first state. The method comprises the following acts:

a) the at least one agent of an associated component is called,
b) after a first training action of the agent, the state of the components and/or of the full system is reassessed, by again collecting the measured variables, so as then to carry out one of the following acts on the basis of the result of the collection:
c1) when the measured variables are constant or improved: perform the next action
c2) when the measured variables have worsened: set an epsilon-greedy value for the training phase to zero, and then perform the next action,
c3) when the measured variables have critically worsened, such as in the case of the realtime response, the training phase is terminated and the system is transferred to the initial state, and then continue with act a,
d) in cases c1 and c2, repeat acts b) and c) until a reinforcement learning episode has concluded,
e) update a policy of the agent, and
f) repeat acts a to e for the next agent.

Advantageous exemplary embodiments are specified in the subclaims.

### BRIEF DESCRIPTION OF THE DRAWINGS

The present embodiments are clarified below by way of figures, in which:

FIG. 1 shows one embodiment of an architectural overview of the system, with a reinforcement learning engine,

FIG. 2 shows an example reinforcement learning agent, and

FIG. 3 shows a schematic sequence of defensive online training according to one embodiment.

### DETAILED DESCRIPTION

The starting point used may also be an already pre-trained system and model provided by the manufacturer, for example. This is also the case if an already existing system is used. However, the agent may also be trained in the real application from the start if this is not otherwise possible, if a simulation would be too complex or too imprecise. This so-called offensive online training may lead to a long training period if a pre-trained model has not been used. To then adapt these models/agents to new, changed, or changing, environments (possibly even during production), i.e., to retrain configuration parameters, as a result, so-called defensive online training is used, for which a dedicated agent advantageously exists for each component (multiagent system).

Multiagent systems are known from the following publications, inter alia: Lowe R., Harb J., Wu Y., Abbeel P., Tamar A., Mordatch I.: Multi-Agent Actor-Critic for Mixed Cooperative-Competitive Environments, arXiv: 1706.02275v3; or Rashid T., Samvelyan M., Schroeder de Witt C., Farquhar G., Foerster J., Whiteson S., QMIX: Monotonic Value Function Factorisation for Deep Multi-Agent Reinforcement Learning, arXiv: 1803.11485v2; or Kaiqing Zhang, Zhuoran Yang, Tamer Basar: Multi-Agent Reinforcement Learning: A Selective Overview of Theories and Algorithms, arXiv: 1911.10635.

In the present prior art, there are two common forms of a multiagent reinforcement learning system:

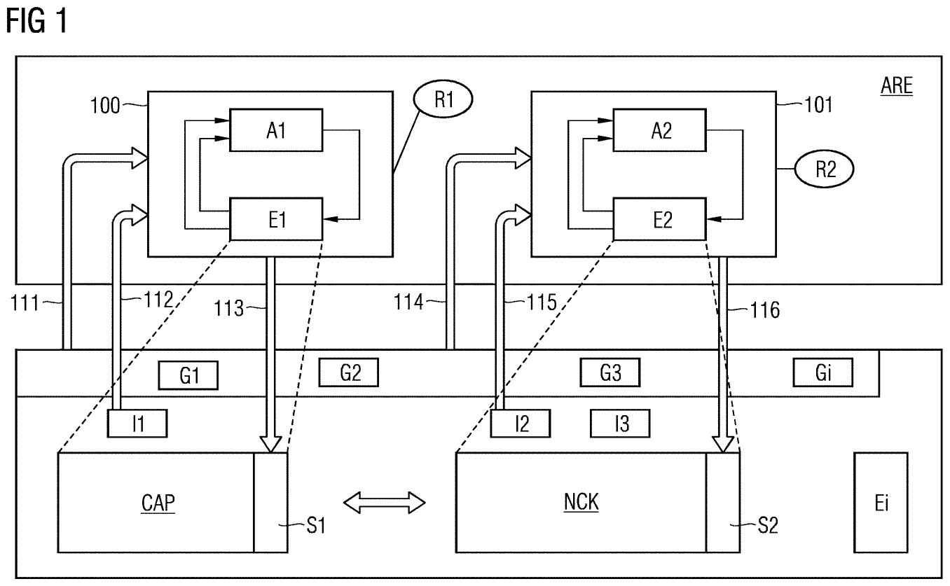

The description that follows should be understood by way of illustration in FIG. 1 too. In a first form, the state of each agent A, A1, A2 includes the state for its own component and the state of the full system, in particular of the measured variables (e.g., utilization level of the CPU or network load), which characterize the properties of the full system that are to be optimized.

Otherwise, in the alternative form, the state includes only the partial state of the system to be optimized, but then contains a downstream network, which receives the actions of the other (dependent) agents as input and therefore indirect information about the overall state.

The possible actions of an agent A, A1, A2 relate to the alteration of the configuration parameters of the individual component. All agents are advantageously combined in an AI RL engine, which may be situated outside the components or is connected to instances of agents inside the components.

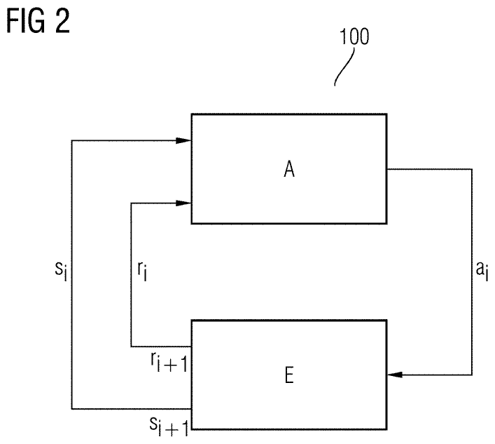

The configuration of the agents for individual components proceeds as shown in more detail in FIG. 2:
the actions a, aᵢ: alterations to component-specific control variables 113, 116 within a restricted value range, for example input of min-max values or of a specified quantity of values (e.g., allocation of additional memory only in 1024-kbyte acts).
the status s1, s2, s3, sᵢ₊₁: contains measured variables that describe the state of the full system, for example diagnosis data, internal measured variables, and so on.
The environment E, E1, E2: corresponds to the respective component, e.g., control access point CAP, numeric control kernel NCK, and so on.
the reward r, rᵢ, rᵢ₊₁: calculated from the respective measured variables.

An important feature of this type of learning in the production setting is that the constant alteration (trial and error) of the control variables takes place in a controlled and careful manner, with the result that the adaptation always keeps to a safe predefined, possibly multidimensional, parameter space and the effects do not endanger the production (workpieces) and safety of the installation and of the persons who may be moving therein. The action space of the agent is thus highly dependent on the parameter space description.

For the adaptation of the system during runtime, a distinction is drawn between two modes, which are each implemented by applicable modes of the AI RL engine.

To train the system after a relatively large change or for a new application, an explicit training phase is performed during runtime, in which the user initiates typical passes (in the case of CNC machines e.g., the production of a typical product) with the aim of training the system for the new circumstances. This practice phase comprises a previously defined period or a number of parts and is typically performed by the end user already in the production environment.

In the course of the training, the agent selects the configuration parameters of the system from its defined action space. The latter consists of discrete parameters that are restricted such that e.g., damage to products or the machine and an excessive drop in the performance of the installation are prevented.

In this scenario, a so-called “greedy” algorithm is used, with a next subsequent state that promises the greatest benefit, or the best result, at the time of selection being selected in acts. The exploration-exploitation rate is defined in such a way that the agent frequently makes randomized decisions to try out many new angles (exploration) and therefore allow fast adaptation to suit the altered system. Worsenings are punished with a high negative reward, however, and so adaptation in unfavorable directions is prevented.

The second mode is provided to use smaller changes to perform continuous adaptations during operation, that is to say in the production phase. In this scenario, even random changes by the agents ought not to result in the target variables of the full system that are to be optimized being worsened to such a degree that e.g., the quality of the workpiece to be produced drops below a specific limit value.

In one advantageous form, this second mode is used during normal productive operation, i.e., the target variables ought to be worsened only to the extent that is immediately acceptable for the resultant properties throughput, quality, wear, etc., of the production. In practice, this could be implemented for example such that the variations that can be observed during normal operation (that is to say without optimization) plus a certain markup would be tolerated.

This is achieved firstly as a result of the discrete acts of the changes in the configuration parameters being so small that an action is unable to drop below a defined limit value (e.g., performance value, utilization level, speed, or temperature). In addition, the proportion of the random changes by the agent for exploration is relatively small, for example the epsilon-greedy value is set to £=10%.

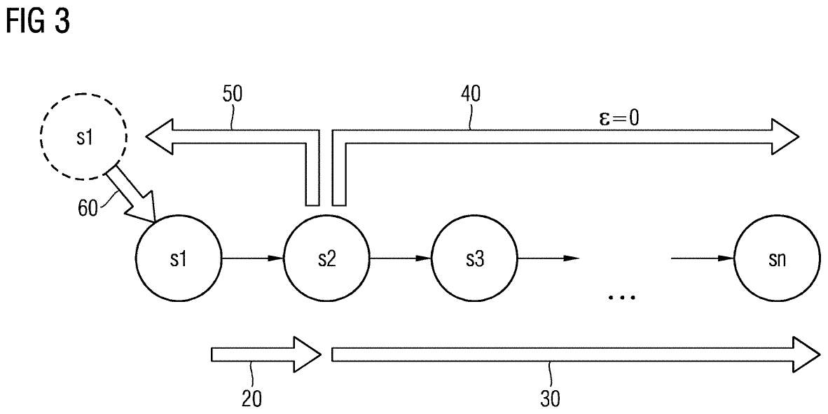

FIG. 3 schematically shows how the defensive online training is implemented. The agent is in state s1 at the start of the training and selects a random action al (see FIG. 2). The real system accepts the configuration parameter changes selected by the action al and thus continues to carry out the process. When the system has stabilized after the changes, the measured data define the next state s2. If the state s2 represents a worsening of the target variables compared with the previous state s1, the epsilon-greedy value £ is set directly to zero to permit no further exploration. The agent is meant to use its previous knowledge to return the system to the initial position s1. After a defined episode length (of e.g., no more than 10 steps), the strategy (also called policy) of the agent is updated. The strategy describes the relationship between the state of the system and the action that an agent carries out on the basis thereof. Adaptation then allows the agent to react in an ever-better manner; the actual learning process takes place. In realtime-critical systems, a worsening from one state to the next (e.g., when time constraints are not expected to be met) results in the episode being immediately ended and the system being reset directly to the stored configuration parameters of state s1. The strategy (policy) of the agent is updated directly after termination of the episode. This prevents changes selected randomly in succession from being able to result in a worsening occurring beyond the predefined limits.

The interaction of the individual agents may fundamentally take place according to known methods, as e.g., described in the publications cited above.

Here too, however, a particular method may be used to restrict the effects of adaptations. The agents are executed in a specific order, with components that have a high potential for change (i.e., for themselves and also with the greatest effects on the full system) being called first and those with small effects being called last. So that the full system does not enter an undesirable state as a result of mutually intensifying negative changes, performance of the acts of the first agent is repeated if a worsening of the target variables has occurred. The same applies to the subsequent agents.

All in all, the method thus comprises the sequence containing the following acts:

1. The system is configured in accordance with the training mode. Two different alternatives are provided for this: mode 1, that is to say with offensive training, for quickly learning new situations:
the value range and the step size of the parameters are restricted to the extent that only uncritical changes are possible with an action. The specification for this is provided explicitly by the user or analogously by pre-trained models. The epsilon-greedy value £ is set to a higher value that results in a desired (greater) exploration.

Otherwise, mode 2 is used, defensive training, with continuous learning: the value range and the step size of the parameters are restricted to the extent that the changes do not substantially worsen the target variables; the epsilon-greedy value £ is set to a lower value, e.g. 10%.

2. The agent A, A1, A2 of the component having the (presumably) greatest influence is called first with the initial state s1. If there is no information available about the influence of the components, the components may be called in a stipulated order. The stipulation is then made for example according to empirical values or results from earlier training phases or episodes. An example in this regard would be the use of fewer CPU cores, which has less of an influence for single-core applications than reducing the main memory.

3. After the first action as of the agent A, A1, A2, the changes in the measured variables G1, G2, . . . I1, I2, . . . are assessed in the new state s2.

In this scenario, a distinction is drawn between 3 cases:

a) improvement in the values: perform the next action aᵢ act 30.
b) worsening of the values: the epsilon-greedy value ε is set to zero, and then the next action is performed until the end of the episode in the final state sn, act 40.
c) critical worsening, generally in the case of negative influence on realtime behavior: terminate, and transfer the system to the initial state s1, continue with act 2, act 50.

4. In the first two cases (3a and 3b), the actions are performed until the episode has concluded. The strategy (policy) of the first agent is then updated.

5. Next, acts 2-4 are performed for all agents.

The specific method described above advantageously allows the behaviour of systems consisting of multiple (software) components and, e.g., controlling (production) processes to be improved by an online training method, and thus adapted to suit changed requirements or applications, without production being substantially impaired or even damage to machines or workpieces occurring. This is achieved by the specific modification of the reinforcement learning method.

The proposed online training of reinforcement learning agents is performed in a (more or less) defensive mode to be possible in the real system. This defensive training strategy ensures that the affected machines and/or products are not exposed to negative influences.

Unsafe influences (e.g., temperature variations) that are frequently ignored in a simulation may be taken into consideration in this case. Furthermore, it is also not necessary, for training the system, to create a simulation in a complex manner beforehand that, during the training, then differs to an ever-greater extent from the system to be simulated. It is therefore also possible to dispense with the use of training data, since the actual system data may be used for the training unit.

The initiation of the training phase and the provision of the new strategy (policy) may be performed in an automated manner; manual triggering by the user is not necessary. The change to online training may take place automatically, for example as a result of adaptation of the epsilon-greedy value.

Another advantage of the method is that the adaptation of the agent to suit a variable environment is possible during operation. Hitherto, this would have resulted in the simulation first needing to be adapted in a complex manner and the training possibly needing to be restarted.

The proposed method advantageously provides two training modes: either fast learning with frequently less than optimum (but always uncritical) settings or slow learning with rare less than optimum (but uncritical) settings.

The use of machine learning methods (here specifically reinforcement learning) allows dynamic adaptation of numerous parameters, or better resource allocation, to be prepared for the future requirements of digitization of industrial production.

In particular the specific runtime adaptations, which each take place in situ, depending on the specific machine tool, the respective product and the respective phase of the production, as a result allow the customer an increase in productivity, faster detection of problems in the system (communication, network, and so on) and therefore consistent better control of the overall manufacturing process.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims can, alternatively, be made to depend in the alternative from any preceding or following claim, whether independent or dependent, and that such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A method for configuring components in a first system with factors that influence the components, wherein the components are operatively linked to one another, and wherein a state of each of the components is determinable by collecting internal measured variables, and a state of the first system is determinable by collecting measured variables relating to the full first system, by a reinforcement learning system, based on at least one agent and information relating to an associated environment, during the runtime of the first system, wherein the components in the first system are initially put into a training mode in order to start a training phase, of episodes, in a first state, the method comprising the following acts:
a) the at least one agent of an associated one of the components having a strategy is called,
b) after a first training action of the agent, the state of the components and/or of the full first system is reassessed, by again collecting the internal measured variables and the measured variable relating to the full first system, so as then to carry out one of the following acts on the basis of the result of the collection:
c1) when the internal measured variables and the measured variables relating to the full first system are constant or improved: perform the next action,
c2) when the internal measured variables and the measured variables relating to the full first system have worsened: set an epsilon-greedy value for the training phase to zero, perform the next action,
c3) when the internal measured variables and the measured variables relating to the full first system have critically worsened, the training is terminated and the first system is transferred to the first state, and continue with act a,
d) in cases c1 and c2, repeat acts b) and c) until the episode has concluded,
e) update the strategy of the agent,
f) repeat acts a to e for the same or a next agent.

2. The method for configuring components as claimed in claim 1, characterized in that the at least one agent comprises multiple agents cooperating as a multiagent reinforcement learning system.

3. The method for configuring components as claimed in claim 1, characterized in that at least some agents of the at least one agent present in the first system are combined in an AI RL engine resident outside the first system.

4. The method for configuring components as claimed in claim 1, characterized in that the components have already been preconfigured using another method prior to performance of the method.

5. The method as claimed in claim 1, characterized in that the action in act b) has two different forms:
in a first form, the result of heavy restriction of a value range and step size of parameters is that only uncritical changes are possible with an action, and the epsilon-greedy value c is set to a value >=10%,
in a second form, the value range and the step size of the parameters are restricted, with the result that changes do not significantly worsen the target variables; the epsilon-greedy value c is set to a value <=10%.

6. The method as claimed in claim 1, characterized in that act a) of the method comprises calling the at least one agent having a greatest influence first.

7. The method as claimed in claim 1, characterized in that the at least one agent selects the parameters, in light of the associated environment, from a defined action space while taking into consideration a limitation to prevent damage.

8. A computer-readable storage medium that has stored instructions that, when executed on at least one computer, are designed to configure components in a first system, with factors that influence the components, wherein the components are operatively linked to one another, and wherein a state of each of the components is determined by collecting internal measured variables, and a state of the first system is determined by collecting measured variables relating to the full first system, by a reinforcement learning system, based on at least one agent and information relating to an associated environment, during the runtime of the system, wherein the components in the first system are initially put into a training mode to start a training phase, of episodes, in a first state, wherein the computer is induced to carry out the following acts:
a) the at least one agent of an associated component of the components is called with a strategy,
b) after a first training action of the at least one agent, the state of the components and/or of the full system is reassessed, by again collecting the internal measured variables and the measured variables relating to the full first system, so as then to carry out one of the following acts on the basis of the result of the collection:
c1) when the internal measured variables and the measured variables relating to the full first system are constant or improved: perform the next action,
c2) when the internal measured variables and the measured variables relating to the full first system have worsened: set an epsilon-greedy value for the training phase to zero, and perform the next action,
c3) when the internal measured variables and the measured variables relating to the full first system have critically worsened, the training is terminated and the system is transferred to the first state, and continue with act a,
d) in cases c1 and c2, repeat acts b) and c) until the episode has concluded,
e) update the strategy of the at least one agent,
f) repeat acts a to e for a next agent.

9. The computer-readable storage medium as claimed in claim 8, characterized in that the at least one agent comprises multiple agents that cooperate as a multiagent reinforcement learning system.

10. The computer-readable storage medium as claimed in claim 8, characterized in that all agents of the at least one agent present in the first system are combined in an AI RL engine that is resident outside the system.

11. The computer-readable storage medium as claimed in claim 8, characterized in that the components have already been preconfigured using another method prior to performance of the method.

12. The computer-readable storage medium as claimed in claim 8, characterized in that the execution by a computer results in the action in act b) having two different forms:
in a first form, the result of a first restriction of a value range and an act size of parameters is that only uncritical changes are possible with an action, and the epsilon-greedy value c is set to a value >=10%,
in a second form, the value range and the act size of the parameters are restricted, with the result that changes do not significantly worsen the target variables; the epsilon-greedy value c is set to a value <=10%.

13. The computer-readable storage medium as claimed in claim 8, characterized in that act a) of the method comprises calling the at least one agent having a greatest influence first.

14. The computer-readable storage medium as claimed in claim 8, characterized in that the at least one agent selects parameters, in light of the associated environment, from a defined action space while taking into consideration a limitation to prevent damage.

15. A system consisting of at least one computer for configuring components with factors that influence the components, wherein the components are operatively linked to one another, and wherein a state of each of the components is determinable by collecting internal measured variables, and a state of the system is determinable by collecting measured variables relating to the full system, by a reinforcement learning system, based on at least one agent and information relating to an associated environment,
during a system runtime, wherein the components are initially put into a training mode in order to start a training phase in a first state, the computer configured to:
a) call the at least one agent of an associated component of the components,
b) after a first training action of the at least one agent, reassess the state of the components and/or of the full system by collection of the internal measured variables and the measured variables relating to the full system, so as then to:
c1) when the internal measured variables and the measured variables relating to the full first system are constant or improved: perform a next action,
c2) when the internal measured variables and the measured variables relating to the full first system have worsened: set the epsilon-greedy value for the training to zero, and perform the next action,
c3) when the internal measured variables and the measured variables relating to the full first system have critically worsened, terminated termin at the training phase and transfer the system to the initial state, and continue with a),
d) in cases c1 and c2, repeat b) and c) until the episode has concluded,
e) update the strategy of the agent,
f) repeat a to e for the same or a next agent.
